(19) United States
(12) Patent Application Publication
(10) Pub. No.: US 2018/0121624 A1
(43) Pub. Date: May 3, 2018

(54) METHODS AND APPARATUS FOR PERSONALISING CONTENT IN A HEALTH MANAGEMENT SYSTEM

(71) Applicant: KONINKLIJKE PHILIPS N.V., EINDHOVEN (NL)

(72) Inventors: JAN MARTIJN KRANS, DEN BOSCH (NL); SASKIA VAN DANTZIG, UTRECHT (NL); MURTAZA BULUT, EINDHOVEN (NL); DENNIS LOMANS, Veldhoven (NL)

(21) Appl. No.: 15/795,646

(22) Filed: Oct. 27, 2017

Related U.S. Application Data
(60) Provisional application No. 62/414,380, filed on Oct. 28, 2016.

(51) Int. Cl. G06F 19/00; G06Q 50/00; G09B 5/06; G09B 19/00

(52) U.S. Cl. CPC G06F 19/3418; G09B 19/00; G09B 5/065; G06Q 50/01

(57) ABSTRACT

There is provided a method of personalising first core content in a health management system. The method includes: obtaining one or more characteristics of the first core content, wherein the first core content is to be presented to a user with a first supplemental content item; obtaining one or more characteristics of the user; and selecting the first supplemental content item from a plurality of supplemental content items based at least in part on the characteristics of the first core content, the characteristics of the user and one or more characteristics of the first supplemental content item. An apparatus and a computer program product are also provided.

### CROSS REFERENCE TO RELATED APPLICATIONS

This application claims the benefit of priority to U.S. Provisional Application No. 62/414,380, filed Oct. 28, 2016, the disclosure of which is herein incorporated by reference in its entirety.

### TECHNICAL FIELD

Various embodiments described herein relate to the field of health management systems. More particularly, but not exclusively, various embodiments relate to methods of personalising content in health management systems.

### BACKGROUND

Digital health management systems such as health coaching programs often include a digital application or “app” that enables a user to interact with the coaching program. Such apps can include a dashboard showing information such as data from one or more health trackers and/or a series of coaching cards in the form of a feed of information. As time progresses and new health-related events take place, new cards arrive in the feed. The delivery conditions and schedule of such cards are defined by the health program.

Various types of cards can be included in the program, such as educational cards, feedback cards, data cards and/or coaching cards. The cards may include content intended to provide advice, motivation or inspiration to a user.

### SUMMARY

As described above, health applications for digital health management systems often include a newsfeed of messages or cards. Some messages can be aimed at motivating the end-user to reach a health-related behavioural goal, as defined in the health management program. Personalization of such messages in the newsfeed is important if the user is to buy in to, or adopt, the program. Such buy-in is required to effectively change the behaviour of an end-user and to help the user to achieve their goal. Personalisation is resource-intensive, however, and it may not be practical to provide personalised messages to every individual that uses the health management system.

One of the issues addressed in this disclosure is therefore how to make cards or messages (or more generally, content) in a health management system appear more personalized, whilst limiting the amount of textual diversification of the messages between users.

As noted above, a limitation with existing approaches is that generic health-related content delivered to a user may not be effective in persuading or convincing the user to take notice of the content and follow any advice contained therein. In order to overcome these problems, it would be valuable to have an improved method and apparatus for personalising content in a health management system.

Therefore, according to various embodiments, there is provided a method of personalising first core content in a health management system, the method including: obtaining one or more characteristics of the first core content, wherein the first core content is to be presented to a user with a first supplemental content item; obtaining one or more characteristics of the user; and selecting the first supplemental content item from a plurality of supplemental content items based at least in part on the characteristics of the first core content, the characteristics of the user and one or more characteristics of the first supplemental content item.

The term “core content” used herein is intended to describe generic content, such a message containing text, which may be delivered to a large number or recipients, and which itself is not personalised to a particular recipient or user. The term “supplemental content” used herein is intended to describe content that may be added to core content in order to enhance the core content by personalising the core content to make it more relevant to a particular recipient.

By supplementing the core content with additional content more specific to the user, the content becomes more personalised and relevant to the user. The user is more likely to take notice of content if they are able to relate personally to it and, consequently, any message contained within the core content may be more effective.

In some embodiments, the method may further include delivering the first core content with the first supplemental content item for presentation to the user.

In some embodiments, selecting the first supplemental content item may include comparing the one or more characteristics of the user and the one or more characteristics of the first core content with characteristics of each supplemental content item in the plurality of supplemental content items; and selecting, as the first supplemental content item, the supplemental content item whose characteristics have the greatest similarity with the one or more characteristics of the user and the one or more characteristics of the first core content.

Selecting the first supplemental content item may include selecting a subset of supplemental content items from the plurality of supplemental content items, wherein each supplemental content item in the subset of supplemental content items has one or more characteristics that correspond to the one or more characteristics of the first core content. Selecting the first supplemental content item may further include ranking the subset of supplemental content items according to a similarity between characteristics of each supplemental content item in the subset of supplemental content items and the one or more characteristics of the user; and selecting the first supplemental content item based on the ranking.

In some embodiments, the method may further include selecting from the plurality of supplemental content items a second supplemental content item to be presented with second core content, the selecting based at least in part on the one or more characteristics of the user, one or more characteristics of the second core content, one or more characteristics of the second supplemental content item, and the first supplemental content item. In some embodiments, the method may include rejecting the second supplemental content item as unsuitable for presentation to the user if the second supplemental content item is the same as the first supplemental content item.

The method may include rejecting a supplemental content item in the plurality of supplemental content items as unsuitable for presentation to the user based at least in part on the one or more characteristics of the user.

According to some embodiments, the method includes presenting the first core content and the first supplemental content item to the user; monitoring a user interaction with the first core content and/or the first supplemental content item to acquire user interaction data; and selecting a third supplemental content item from the plurality of supplemental content items to be presented with third core content based at least in part on the one or more characteristics of the user, one or more characteristics of the third core content, one or more characteristics of the third supplemental content item and the user interaction data.

The monitored user interaction data may include at least one of: a posture of the user as the user interacts with the first core content and/or the first supplemental content item; an amount of time spent interacting with the first core content and/or the first supplemental content item; a physiological or psychological response of the user as the user interacts with the first core content and/or the first supplemental content item; a measured distance between the user and the first core content and/or the first supplemental content item; a reaction or response of the user to the first core content and/or the first supplemental content item, the reaction or response received via a user interface; and a physical interaction between the user and a device on which the first core content and/or the first supplemental content item are presented.

In some embodiments, obtaining one or more characteristics of the user may include receiving data from at least one sensor associated with the user. The at least one sensor may include a camera, and the obtaining one or more characteristics of the user may include performing an image recognition process on an image acquired by the camera to obtain the one or more characteristics of the user.

The at least one sensor may measure one or more physiological, behavioural and/or psychological characteristics of the user.

In some embodiments, each of the plurality of supplemental content items includes at least a portion or element of a photograph, a video, an audio clip, an image, a cartoon, an animation, an illustration, an emoticon, an olfactory presentation or a haptic presentation.

According to some embodiments, the method may further include generating a customised supplemental content item by combining together a plurality of selected supplemental content items. The method may include modifying the selected first supplemental content item based on the one or more characteristics of the user and/or the one or more characteristics of the first core content.

The one or more characteristics of the user may include at least one of a physical characteristic, a characteristic associated with the location of the user, a characteristic associated with a user activity, and a characteristic associated with a behaviour of the user.

The one or more characteristics of the first core content may include at least one of: a date, a season and/or a time that the first core content is scheduled to be delivered to the user; and a word or character present in the first core content.

The one or more characteristics of the first supplemental content item include at least one of: a characteristic of a subject depicted in the first supplemental content item; and a context of a subject depicted in the first supplemental content item.

According to various embodiments, there is also provided an apparatus including: a content item presentation module for presenting core content and supplemental content to a user; and a processor; wherein the apparatus is configured to perform the method of any of the preceding claims.

According to various embodiments, there is also provided a computer program product including a non-transitory computer readable medium, the computer readable medium having computer readable code embodied therein, the computer readable code being configured such that, on execution by a suitable computer or processor, the computer or processor is caused to perform the method described above.

Other advantageous features will be apparent from the following description.

### BRIEF DESCRIPTION OF THE DRAWINGS

For a better understanding, and to show more clearly how it may be carried into effect, reference will now be made, by way of example only, to the accompanying drawings, in which:

FIG. 1 is a schematic diagram of an arrangement of computing devices in a network;

FIG. 2 is a schematic diagram of a user device according to an embodiment of the invention;

FIG. 3 is a block diagram illustrating an example of a method of personalising content in a health management system according to embodiments of the invention;

FIG. 4 is a block diagram illustrating a further example of a method of personalising content in a health management system according to embodiments of the invention;

FIG. 5 is a block diagram illustrating a further example of a method of personalising content according to embodiments of the invention;

FIG. 6 is a block diagram illustrating a further example of a method of personalising content according to embodiments of the invention;

FIG. 7 is a block diagram illustrating a further example of a method of personalising content according to embodiments of the invention;

FIG. 8 is a block diagram illustrating a further example of a method of personalising content according to embodiments of the invention; and

FIG. 9 is an illustration of example supplemental content items which have been generated or modified.

### DETAILED DESCRIPTION

The description and drawings presented herein illustrate various principles. It will be appreciated that those skilled in the art will be able to devise various arrangements that, although not explicitly described or shown herein, embody these principles and are included within the scope of this disclosure. As used herein, the term, “or,” refers to a non-exclusive or (i.e., and/or), unless otherwise indicated (e.g., “or else” or “or in the alternative”). Additionally, the various embodiments described herein are not necessarily mutually exclusive and may be combined to produce additional embodiments that incorporate the principles described herein.

As noted above, the digital health management system may be used to motivate a user to achieve a health-related goal. For example, for a user whose goal is to increase the amount of activity they take part in on a daily basis, the digital health management system may deliver content to the user, for example in the form of a message or a digital ‘card’ which serves to encourage the user to perform a particular activity or to become more active generally.

The digital health management system may include a digital application configured to be executed on a user device, such as a computer or a smartphone. The digital health management system may include computer program software capable of being executed on the user's device, and may be stored on the device itself or remotely, for example on an external computer system or server capable of interacting with the user's device.

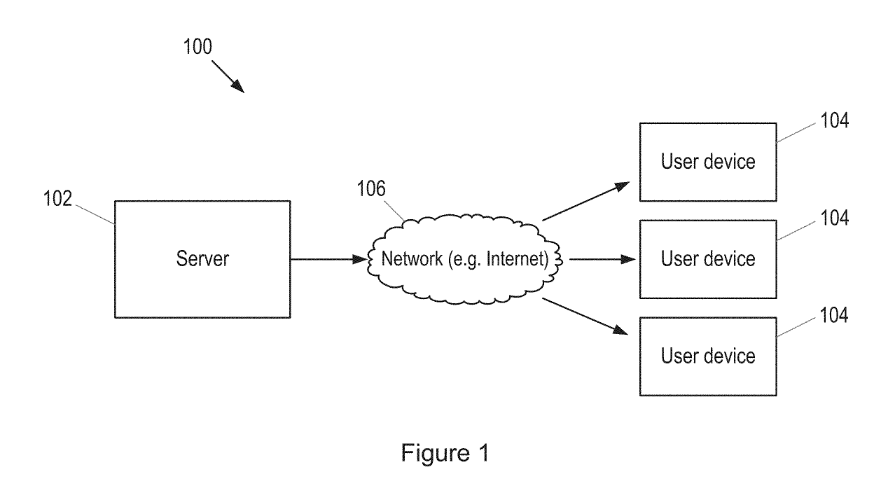

FIG. 1 shows an example arrangement 100 in which a digital health management system may operate on one or more user devices. The arrangement 100 includes a server 102, which may include one or more computing devices located, for example, at the premises of a company providing the digital health management system. The server 102 may include software which can be executed by processing apparatus associated with the server, and may be configured to provide the digital health management system, for example, in the form of a digital application, to one or more user devices 104. In the example shown in FIG. 1, the server 102 is in communication with each user device 104 via a network 106, which may be a wired network or a wireless network capable of enabling communications, for example, via the internet.

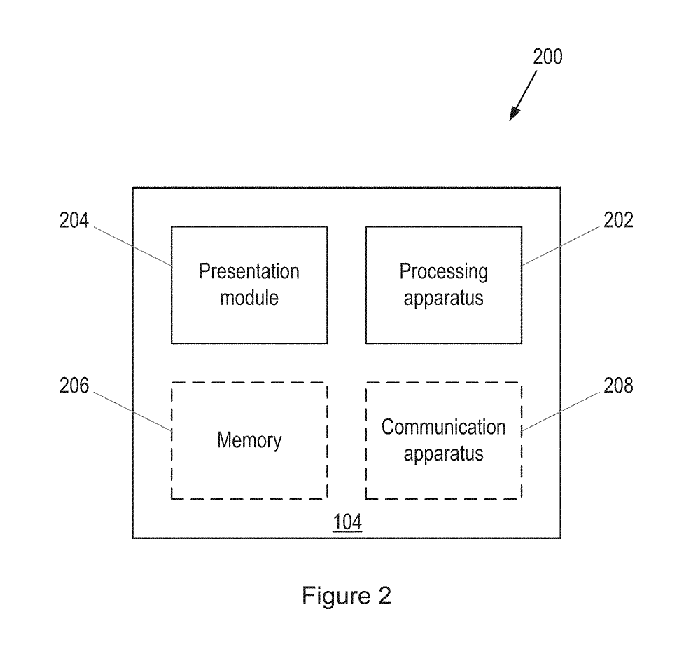

FIG. 2 shows an alternative arrangement 200 in which a health management system is capable of being contained on and executed by a user device 104. The user device 104 includes processing apparatus 202 and a presentation module 204. The processing apparatus 202 of the user device 104 may be configured to perform the functions of the server 102 of FIG. 1. In other words, the user device 104 of FIG. 2 may be configured to execute a digital health management application itself, such that the user device need not communicate with a remote server via a network. As such, the user device 104 of FIG. 2 may include a memory 206 capable of storing programme code (e.g. the digital health management application). The user device 104 of FIG. 2 may further include a communication apparatus 208, such as a transmitter and/or a receiver, capable of communicating via a wired or wireless network with one or more other user devices and/or with a server such as the server 102 in FIG. 1. Since, in some embodiments, the user device 104 may not include the memory 206 and/or the communication apparatus 208, these features are shown in FIG. 2 with dashed lines.

The user device 104 may be any type of device capable of executing a digital application, such as a smartphone, a mobile telephone, a desktop or laptop computer, a tablet computer, a smartwatch or a computer device incorporated into another product such as a home appliance. In general, the user device 104 is a device capable of providing health-related information to a user, possibly in real-time, so that the user is able to receive such information ‘on-the-go’, at a convenient time, and without much, if any, user input being required.

The digital health management system is configured to deliver an item of core content to one or more users via one or more user devices 104. As noted above, the core content may include a virtual, or digital card which, in some embodiments, may include a message, such as a message containing text, intended to inspire or motivate the user to perform or take part in a health-related activity. The core content may be generic content suitable for and relevant to a large number of users, and may be chosen randomly from a library or database of content, or based on one or more parameters as discussed below. In one example, the core content may include a message containing text which reads ‘Find a walking buddy—walking is more fun if you do it together’. In another example, the core content may read ‘Change your routine and cycle to work instead’. In yet another example, the core content may include a motivational quote from a celebrity. While the core content may be intended to inspire or motivate a user to perform a health-related activity (e.g. walking in a group), the content may be considered more inspirational and/or motivational by the user if the content were more personalised and relevant to the user. The present disclosure therefore provides a method of personalising the core content by enhancing the core content with a supplemental content item which is of particular relevance relevant to the user.

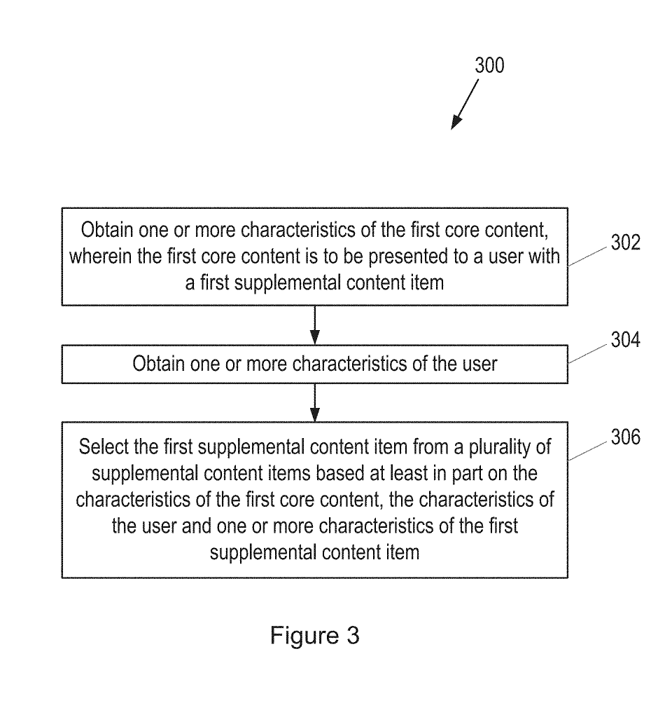

FIG. 3 shows a block diagram illustrating an example method of personalising content in a health management system. The method 300 includes, at step 302, obtaining one or more characteristics of first core content, wherein the first core content is to be presented to a user with a first supplemental content item. The first core content may be obtained through a random selection of core content from a plurality of core content items stored, for example, in a database or otherwise stored in a memory. Alternatively, the first core content may be provided by a central computer system or server, such as the server 102 shown in FIG. 1. The characteristics, or attributes, of the core content may include characteristics contained within, associated with or representative of the core content. For example, in the scenario where the core content includes a message containing text, the characteristics of the core content may include one or more characters, words and/or phrases included in the text, and/or one or more keywords or tags associated with the core content (e.g. the message containing text), which may be stored as metadata associated with the core content. The characteristics of the core content may be obtained by a content scanning procedure performed by a processing apparatus, which may, for example, scan through the text of the core content, and identify particular characters, words and/or phrases that can be used to personalise the core content. For example, in the case where the core content includes a message containing text reading ‘Find a walk buddy—walking is more fun if you do it together’, characteristics relating to or associated with, the core content might be considered to be the phrase ‘walk buddy’ and the words ‘walking’ and ‘together’.

In general, each item of core content may be characterised using groups of characteristics, such as ‘person characteristics’, which include characteristics relating to a person shown or referred to in an item of core content, ‘activity characteristics’, which include a type of activity shown or referred to in an item of core content, an intensity of the activity, and/or whether the activity is intended to be performed alone or with others, and ‘context characteristics’, which include characteristics of a context shown or referred to in an item of core content, such as a date, time and/or season that the core content is intended to be delivered, a geographical location included in the core content, and/or whether the core content mentions that the activity is to be performed indoors or outdoors. As will be appreciated, the groups of characteristics and the specific characteristics listed above are merely examples, and other characteristics relating to the core content may be obtained.

In order to make the first core content more personalised to a particular user, the method 300 includes, at step 304 obtaining one or more characteristics of the user. As is explained in more detail below, the characteristics of the user may be obtained in various ways. In some embodiments, the characteristics of the user are obtained from information provided by the user, such as information provided when a user sets up an account with the digital health management system. In other embodiments, the characteristics of the user may be obtained via a questionnaire answered by the user, via a user profile associated with the user, via purchases made by the user and/or by one or more sensors associated with the user. In some embodiments, personalisation of core content may be achieved using food or nutrition related aspects. For example, an item of core content might include a message relating to nutritional content of food. That core content might be personalised by selecting a supplemental content item based on food or drink consumed by the user. Such information may be obtained, for example, from food purchase information or from a food diary or log entered by the user.

Examples of characteristics of the user that may be obtained in step 304 and used to personalise the first core content include the gender of the user, the ethnic origin of the user, the age of the user, the place (e.g. town or country) of residence of the user, the marital status of the user, health-related activity preferences (e.g. preferred sports, food types and eating habits) of the user, the weight, body shape and/or body mass index (BMI) of the user, and/or one or more other measures of healthiness of the user. Of course, the characteristics listed here are mere examples of characteristics of the user that may be obtained in the method 300 more or fewer characteristics of the user may be obtained in step 302 depending on the amount of information (i.e. the number of characteristics of the user) available.

Once the characteristics of the core content and the characteristics of the user have obtained (steps 302 and 304), the method 300 includes, at step 306, selecting a first supplemental content item from a plurality of supplemental content items based at least in part on the characteristics of the first core content, the characteristics of the user and one or more characteristics of the first supplemental content item. The supplemental content item is intended to include content that enhances the core content by personalising the core content to make it more relevant to the user. In some embodiments, the supplemental content items may include media assets which can be presented using suitable media presentation apparatus. The first supplemental content item may, in some embodiments, include at least a portion or an element of a photograph, an image, a video, an audio clip, a cartoon, an animation, an illustration, an emoticon, an olfactory presentation (e.g. a scent) or a haptic presentation. The supplemental content item may be two dimensional or three dimensional (if visual), and may include a combination of any of the above. The expression ‘haptic presentation’ as used herein is intended to include a presentation to the user through his or her sense of touch which, in some embodiments, may include a tapping sensation, a vibration or a pulsing sensation which can be felt by a user, for example through the user device 104.

The selection of the first supplemental content item is made from a plurality of supplemental content items which may be stored, for example, in a database either in the user device 104 or in the remote server 102. The core content may be stored in the same database or separately. The selection is based at least in part on the characteristics of the first core content (e.g. words to be presented to the user), the characteristics of the user (e.g. the age, gender and general health of the user) and one or more characteristics of the first supplemental content item (e.g. elements of the supplemental content item). Each of the plurality of supplemental content items has one or more characteristics, or attributes, associated therewith. As with the user characteristics and the core content characteristics, the characteristics of the supplemental content items may be stored as metadata. In some embodiments, the characteristics of the supplemental content items include one or more tags or keywords which may be deduced automatically or entered manually, and which relate to elements, subjects or components within the supplemental content items. For example, in the case where a supplemental content item includes a photograph of a group of elderly men walking along a beach, the characteristics of that supplemental content item might include a list of tags describing the photograph, such as ‘group’, ‘male’, ‘senior’, ‘walking’, ‘low intensity’, ‘beach’ and ‘outdoors’. In some embodiments, the characteristics, or tags, may be grouped or categorised into similar or related characteristics such as, for example, ‘person characteristics’ which describe or relate to one or more people shown in the photograph, ‘activity characteristics’, which include characteristics describing or relating to an activity shown or depicted in the photograph, and ‘context characteristics’ which include characteristics describing or relating to the context, or background information shown or depicted in the photograph, such as where the people are, the time of day depicted in the photograph, or the weather or season depicted in the photograph. Of course, for supplemental content items other than photographs different characteristics and groups of characteristics may be used. For example, if the supplemental content item is a song, then the characteristics might include a tempo of the song, a subject of the lyrics of the song, and/or a genre of the song.

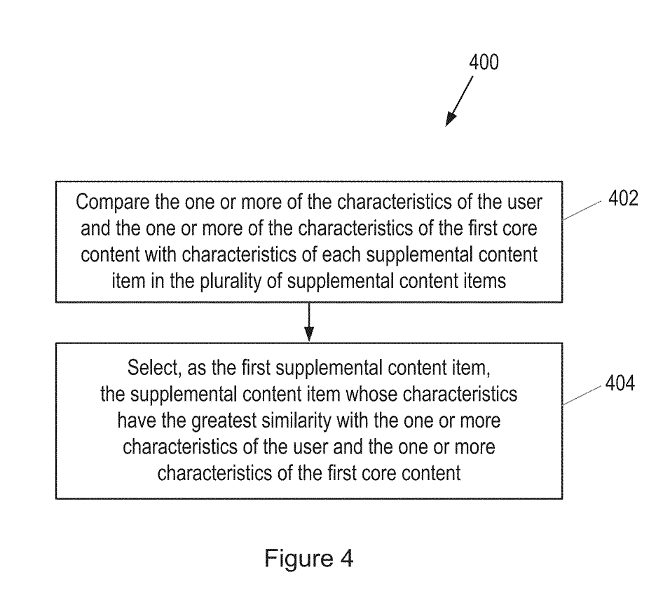

In order to select a first supplemental content item from the plurality supplemental content items (step 306), the method 300 may compare the characteristics of the first core content, the characteristics of the user and the characteristics of one or more of the supplemental content items in the plurality of supplemental content items, and base the selection on a measure of similarity between the characteristics. The manner in which a measure of similarity between various characteristics may be determined is discussed below with reference to FIG. 4.

FIG. 4 illustrates an example method 400 which may be used in some embodiments to select the first supplemental content item. The method 400 includes, at step 402, comparing the one or more characteristics of the user and the one or more characteristics of the first core content with characteristics of each supplemental content item in the plurality of supplemental content items. The method 400 further includes, at step 404, selecting, as the first supplemental item, the supplemental content item whose characteristics have the greatest similarity with the one or more characteristics of the first core content. In other words, the method selects the supplemental content item whose characteristics are most similar to the user characteristics and the first core content characteristics.

The measure of similarity between the various characteristics may be determined in various ways. For example, in some embodiments, the measure of similarity between characteristics of the supplemental content items and the characteristics of the user and of the core content may be based simply on a number of characteristics that match. In some examples, the selection of the supplemental content item may be based on a single user characteristic. For example, if the user has supplied his or her body mass index (BMI), then a supplemental content item may be selected which includes an image of a person having a similar BMI. In other embodiments, some characteristics of the core content, the user and/or the supplemental items may be weighted based on their relevance or importance. In other embodiments, the measure of similarity may be based on an analysis of the characteristics of the supplemental content items and how they relate to the characteristics of the user and/or the first core content.

The measure of similarity between characteristics of the supplemental content items and the characteristics of the user and of the core content may be different for different types of content. If the user characteristics, the core content characteristics and the supplemental content item characteristics can be parameterised (i.e. described or represented in terms of features) then various similarity measures can be used. For example, if the characteristics of the user include an image of the user's face, then facial recognition techniques may be used to determine the size of various facial features and the distances between them. An image of a face having similar facial features may be selected as the supplemental content item. Similar techniques may be used if the user characteristics include an image of the user's body. In such an example, an image having a similar size and/or shape may be selected as the supplemental content item. In some examples, if a user characteristic includes speech of a user, then characteristics of the speech may be analysed, and a synthetic speech voice may be generated and selected as the supplemental content item. Similarly, a user's speech may be analysed to obtain language characteristics (e.g. whether the user typically uses short words or longer, complicated words, and/or the complexity of sentences used) and a message (e.g. a message containing text, or a spoken message) having similar characteristics may be chosen as the supplemental content item. In some examples, if the user characteristics include a user's preference for a particular type or genre of music, then a particular song which matches that preference may be selected as the supplemental content item.

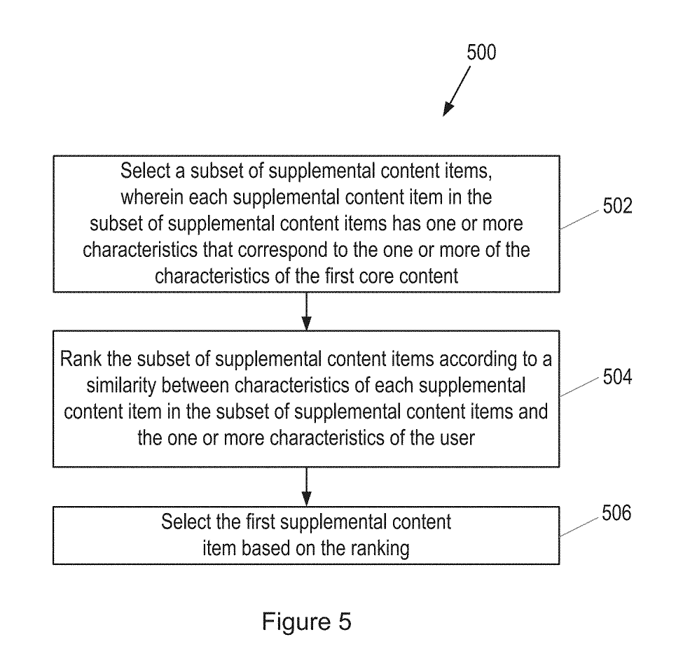

An alternative method for selecting the first supplemental content item is illustrated in FIG. 5. The method 500 of FIG. 5 includes, at step 502, selecting a subset of supplemental content items from the plurality of supplemental content items, wherein each supplemental content item in the subset of supplemental content items has one or more characteristics that correspond to the one or more characteristics of the first core content. In this way, the plurality of supplemental content items from which a selection is to be made is reduced to a subset which contents supplemental content items having at least one characteristic that corresponds with the first core content. For example, if the core content includes the characteristics ‘walking’, ‘group’ and ‘low intensity’, based on the words included in the core content, then step 502 would reduce the total number of supplemental content items to a subset including only those supplemental content items having corresponding characteristics (for example, supplemental content items depicting people walking, supplemental content items depicting a group of people, and/or supplemental content items depicting a low intensity activity). By reducing the number of supplemental content items from which to make the selection, the processing power and time expended in making the selection may be reduced.

The method 500 further includes, in step 504, ranking the subset of supplemental content items according to a similarity between characteristics of each supplemental content item in the subset of supplemental content items and the one or more characteristics of the user. Thus, in step 504, the method 500 re-orders the supplemental content items in the subset by prioritising those supplemental content items having characteristics with the greatest measure of similarity to the characteristics of the user.

At step 506, the method 500 selects the first supplemental content item (i.e. the supplemental content item to personalise the core content) based on the ranking performed in step 504. In some embodiments, the highest ranked supplemental content item (that is the supplemental content item in the subset whose characteristics are most similar to the characteristics of the user) is selected as the first supplemental content item. In other embodiments, the selection of the first supplemental content item based on the ranking may be performed using some other criteria.

In some embodiments, two or more of the supplemental content items in the subset may include characteristics having the same measure of similarity and, therefore, may be ranked or prioritised equally. In such cases, the selection of the first supplemental content item may be made by selecting one of the equally ranked items at random.

In some embodiments, a memory, such as the memory 206 in the user device 104, or a memory associated with the server 102, may be used to store a record of which supplemental content item is selected. In this way, if the same core content is to be delivered to the same user at a later time, the record of which supplemental content item was displayed previously may be recalled, so that the same supplemental content item or a similar supplemental content item may be selected. Similarly, by maintaining a record of the supplemental content items that have been selected, it is also possible to ensure that the same supplemental content item is not selected if it has been selected previously and if it would be undesirable to select and present the same item again.

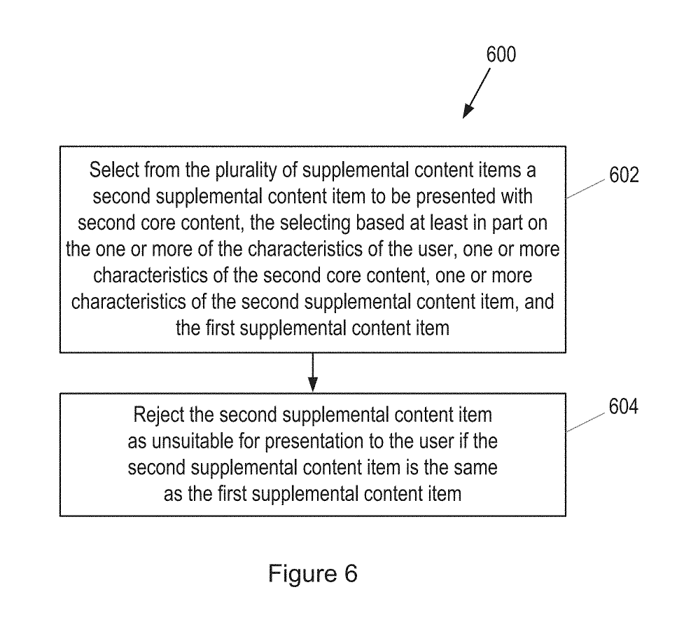

FIG. 6 illustrates an example of how the selection of a supplemental content item might be based on a previously-selected supplemental content item. The method 600 of FIG. 6 includes, at step 602, selecting from the plurality of supplemental content items, a second supplemental content item to be presented with second core content, the selecting based at least in part on the one or more characteristics of the user, one or more characteristics of the second core content, one or more characteristics of the second supplemental content item, and the first supplemental content item. In other words, the selection of the second supplemental content item may be based in part on the first (i.e. previously-selected) supplemental content item. In some embodiments, the second core content might, for example, be a second message containing text to be presented to a user to whom a first message containing text (first core content) and a first supplemental content item have already been presented. In some embodiments, the method 600 may further include, at step 604, rejecting the second supplemental content item as unsuitable for presentation to the user if the second supplemental content item is the same as the first supplemental content item. In other words, if the second supplemental content item is identified as being the same as the first supplemental content item (or the same as any previously selected and/or presented supplemental content item), then the second supplemental content item may not be presented to the user. In some embodiments, the method may further include selecting an alternative supplemental content item.

One or more of the plurality of supplemental content items may be rejected as unsuitable for presentation to the user for other reasons. For example, it may be deemed inappropriate to present certain supplemental content items to particular users in order to avoid the risk of offending or upsetting a user. A judgement regarding the suitability of a particular supplemental content item for presentation may be based on information relating to the user, such as the one or more characteristics of the user. If, for example, a particular user has provided information to the health management system indicating that he or she is unable to walk, then the method may reject those supplemental content items relating to walking as unsuitable for presentation to that particular user.

In general, therefore, the method may further include rejecting a supplemental content item in the plurality of supplemental content items as unsuitable for presentation to the user based at least in part on the one or more characteristics of the user.

Once the method has selected a supplemental content item suitable for personalising the core content, then it may be delivered to the user with the core content. Thus, the method may further include delivering the first core content with the first supplemental content item for presentation to the user. If the method is performed on a remote server 102, and the core content and the supplemental content item are stored remotely from the user device 104, then the delivery of the core content and the supplemental content may include sending or transmitting the items to a user device 104. However, if the method is performed by processing apparatus 202 within the user device 104, then the delivery of the core content and the supplemental content item may include sending the items from the memory 206 to the presentation module 204 of the user device. The presentation module 204 may be associated with any suitable presentation device or devices for presenting the supplemental content item and core content. Thus, the presentation module 204 may be associated with and/or connected to at least one of a display screen, a touchscreen, a speaker, a pulse generator and a vibration generator.

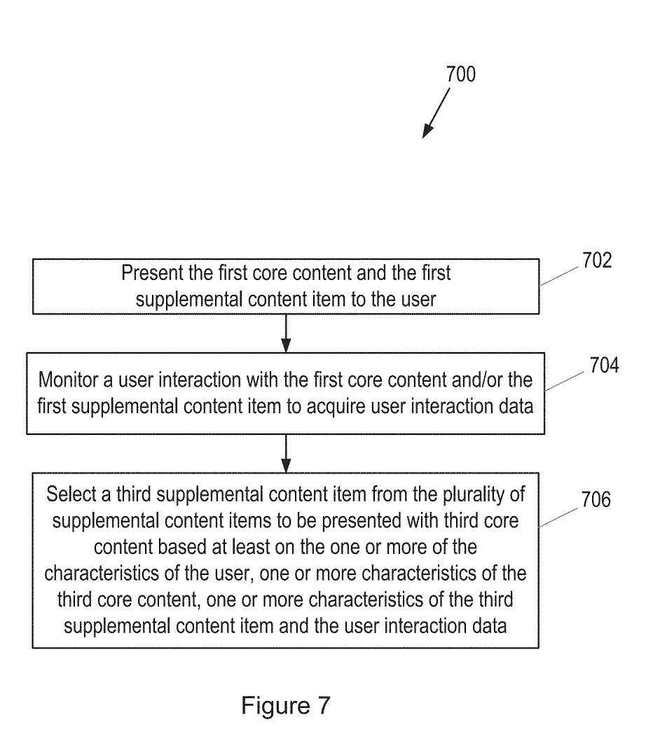

The user device 104 may, in some embodiments, include or be associated with one or more sensors configured to measure an interaction of the user with the user device or with the first supplemental content item after the item has been presented to the user. The sensors may be configured to measure one or more physiological, behavioural and/or psychological characteristics of the user. FIG. 7 illustrates an example of a method in which such user interactions are monitored. The method 700 includes, at step 702, presenting the first core content and the first supplemental content item to the user. At step 704, the method 700 includes monitoring a user interaction with the first core content and/or the first supplemental content item to acquire user interaction data. As is discussed below, the user interaction data may be acquired using various sensors configured to detect and monitor various interactions between the user and the presented core content and/or supplemental content item. The method 700 continues, as step 706, by selecting a third supplemental content item from the plurality of supplemental content items to be presented with third core content based at least in part on one or more of the characteristics of the user, one or more characteristics of the third core content, one or more characteristics of the third supplemental content item and the user interaction data. In other words, the manner in which the user interacts with a previously-presented core content item and/or a previously-presented supplemental content item may be used in the selection of a further supplemental content item. By monitoring the user interaction with the previously-presented core content/supplemental content item, it may be possible to determine if the user particularly likes or dislikes particular content. If a particular supplemental content item is found to be disliked by the user, then a similar supplemental content item may be avoided in a future selection process and, if a particular supplemental content item is found to be particularly liked or enjoyed by the user, then similar supplemental content items may be selected in future selection processes, or may be prioritised above other, less favourable items.

Various sensors may be used to monitor the user's interaction with the presented core content and supplemental content item, and user interaction data may be obtained using one or more such sensors. In some embodiments, the user interaction data may include a posture, and change in posture, or a movement of the body of the user as the user interacts with the core content and/or the supplemental content item. For example, if the user suddenly backs away from the user device 104 when one or both of the items are presented, it may be concluded that the user dislikes one or both of those items. Conversely, if the user displays more positive body language when one or both of the items are displayed, then it may be concluded that the user likes one or both of the items. The posture of the user may be monitored, for example, by a camera in or associated with the user device 104.

In some embodiments the user interaction data may include an amount of time spent interacting with the core content and/or the supplemental content item. A long interaction time may be indicative of greater enjoyment of one or both of the items. The time spent interacting with the core content and/or supplemental content item may be measured using a camera and/or timer in or associated with the user device 104.

In some embodiments, the user interaction may include a physiological or psychological response of the user as the user interacts with the first core content and/or the first supplemental content item. An increase in the user's heart rate, for example, may be indicative of greater enjoyment of one or both of the items. A camera in or associated with the user device 104 may be used to monitor the physiological or psychological response of the user.

In some embodiments, the user interaction data may include a measured distance between the user and the core content and/or the supplemental content item. As noted above, a shorter distance between the user and the user device presenting the core content and the supplemental content item may be indicative of a greater enjoyment. A camera in or associated with the user device 104 may be used to monitor the measured distance.

In some embodiments, the user interaction data may include a reaction or response of the user to the core content and/or the supplemental content item. The reaction or response may be received via a user interface. Such a user interface may be included in or associated with the user device 104, and may include a voice sensor or microphone, a facial response sensor or a physical input sensor to measure a physical input via a user interface, such as pressing or touching a ‘like’ icon or a ‘dislike’ icon on a touchscreen display.

In some embodiments, the user interaction data may include a physical interaction between the user and a device on which the core content and/or the supplemental content item are presented. Sensors in or associated with the user device 104, such as a button or a touchscreen may be used to monitor such a physical reaction. If, for example, the supplemental content item is presented on a display screen, then a physical interaction of the user with the display screen may be used to determine the user's enjoyment of the supplemental content item. For example, a user interaction to enlarge an image presented to the user might be indicative of enjoyment of the item.

Of course, sensors other than those discussed above will be known to those skilled in the art, and may be used to monitor user interaction data upon which subsequent selections of supplemental content items may be based.

In some embodiments, the sensors may be used to monitor the user and acquire the user interaction data while the user views/receives the core content and/or the selected supplemental content item and change the way in which a selection is made in future. For example, if, while monitoring a user, it is determined that a particular combination of core content and a supplementary content item causes a sudden reaction (for example a change in heart rate, a change in skin temperature, a sudden user motion, a change in pupil size or a change in eye blink frequency), then the system may determine that the particular combination of content has affected the user and caused one or more physiological effects. Such a combination of content may be given more or less weight in future content selections.

One or more of the sensors discussed above, which may be used for monitoring user interactions of the user with the user device 104, or other sensors associated with the user, may be used to obtain one or more of the characteristics of the user. As noted above, characteristics of the user may be obtained through information entered by a user, for example, when setting up a user profile or through answering questionnaires provided to the user by the health management system. In some embodiments, however, one or more characteristics of the user may be obtained from at least one sensor associated with the user. The sensor associated with the user may be a sensor in or connected to the user device 104. In some embodiments, the sensor may be a camera, and the one or more characteristics of the user may be obtained by performing an image recognition process on an image acquired by the camera. For example, from an image acquired by the camera, it may be possible to determine the height and/or approximate weight of the user, the gender of the user, an approximate age of the user, and a location of the user by recognising objects in the image. Other sensors, such as a Global Positioning System (GPS) device, may be used alone or in combination with one or more other sensors, such as the camera, in order to provide GPS coordinates of the user so that the health management system can determine the user's location, the general surroundings of the user (for example, mountains, a beach, a forest or a city), and/or the country or continent in which the user is located. In some embodiments, sounds and/or scents in the environment may be used to assist in making a determination of the user's location and/or the user's immediate surroundings.

In some embodiments, data acquired by the camera and/or the GPS device may be combined with information acquired from other sensors and/or sources. For example, the time, the date, and current weather may be obtained and used as characteristics of the user in order to select a relevant supplemental content item to personalise the core content. By monitoring location data over a period of time, it may be possible to determine the user's preference of a particular place (for example, shops, restaurants, locations) and activities. Such preferences may be used as characteristics of the user for future supplemental content item selections.

A camera may be used to measure and/or monitor one or more clinical functions of a user in an unobtrusive manner. For example, a camera may be used to measure a heart rate, a respiration rate, a respiration depth, inhalation and exhalation cycles, and an oxygen saturation (SO₂)—particularly a peripheral oxygen saturation (SpO₂)—level of the user.

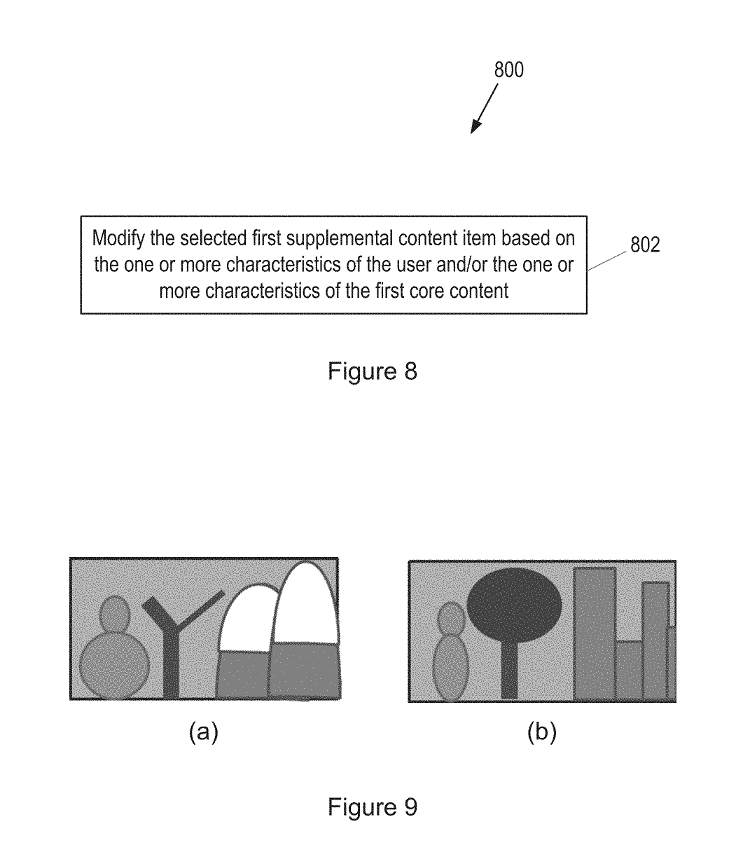

In order to further personalise the core content to be delivered to the user, some embodiments involve generating a supplemental content item or modifying an existing supplemental content item to make it relevant to the user. FIG. 8 illustrates an example of a method in which a supplemental content item is modified. The method 800 includes, at step 802, modifying the selected first supplemental content item based on the one or more characteristics of the user and/or the one or more characteristics of the first core content.

In embodiments where the supplemental content items are photographs, images, cartoon-like illustrations, videos, animations and the like, individual components or elements of the items may be manipulated, added, deleted, combined or otherwise modified in order to improve that content item's relevance to the user. The elements may be customised, for example, to represent the user, the user's lifestyle, the user's current location or environment, the climate or weather at the location of the user, and the like.

In some embodiments, an image may be generated from one or more individual components, each selected based on one or more of the characteristics of the user and/or the core content. FIG. 9 illustrates two examples of supplemental content items generated based on such characteristics. In the example shown in FIG. 9, the illustrations are cartoon-like images, each generated from three different tuneable or customisable components or elements. The illustrations in FIG. 9 include a first element representative of the user (i.e. the person shown on the left of the images), a second element representative of the season or time of year during which the content item is to be delivered to the user (i.e. the tree shown in the middle of the images) and a third element representative of the location of the user (i.e. the element indicating the user's surroundings, shown on the right of the images).

The first element may be customised based on one or more characteristics of the user. For example, the first element in FIG. 9(a) represents a relatively large or heavy person. In contrast, the first element in FIG. 9(b) represents a relatively small or lightweight person. The second element in FIG. 9(a) represents a tree having no leaves, which may be indicative of an autumnal or wintry time of year, whereas the second element in FIG. 9(b) represents a tree with leaves, which may be indicative of spring or summer. The third element in FIG. 9(a) represents mountainous surroundings, whereas the third element in FIG. 9(b) represents a city landscape. Of course, each of the elements shown in FIG. 9 may be customised further and generated images may contain more or fewer elements in order to accurately represent the user and/or their surroundings and context. For example, an element indicative of the current weather may be included, such as an image of the sun, or an image or animation of rain.

As noted above, one or more sensors associated with the user may be used to obtain characteristics of the user. Therefore, such sensors may be used to obtain information which can subsequently be used to generate or modify an image or any other supplemental content item (e.g. an animation, a video, and the like). Such modifications may, in some embodiments, be made in real time as updated information becomes available. In other embodiments, supplemental content items may be generated or customised when the user provides the health management system with relevant information.

Each of the elements that can be included in an image may be stored in a memory associated with the health management system, and a selection of an element to be included in the generated image may be based on the characteristics of the user, the characteristics of the core content to be personalised, and the characteristics of the element itself. Thus, an element to be included in a generated image can itself be considered to be a supplemental content item, which may be combined with one or more additional content items in an image.

There may be provided a method of personalising core content in a health management system, the method including: obtaining one or more characteristics of the core content, wherein the core content is to be presented to a user with a supplemental content item; obtaining one or more characteristics of the user; and combining a plurality of elements to form the supplemental content item, each element being selected based on at least one of: the characteristics of the core content, the characteristics of the user and one or more characteristics of each of the elements. The method may further include modifying at least one of the elements based on the characteristics of the user.

Variations to the disclosed embodiments can be understood and effected by those skilled in the art in practicing the principles and systems disclosed herein, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage.

A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

It should be apparent from the foregoing description that various example embodiments of the invention may be implemented in hardware or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

1. A method of personalising first core content in a health management system, the method comprising:
obtaining one or more characteristics of the first core content, wherein the first core content is to be presented to a user with a first supplemental content item;
obtaining one or more characteristics of the user; and
selecting the first supplemental content item from a plurality of supplemental content items based at least in part on the characteristics of the first core content, the characteristics of the user and one or more characteristics of the first supplemental content item.

2. A method according to claim 1, further comprising:
delivering the first core content with the first supplemental content item for presentation to the user.

3. A method according to claim 1, wherein selecting the first supplemental content item comprises:
comparing the one or more characteristics of the user and the one or more characteristics of the first core content with characteristics of each supplemental content item in the plurality of supplemental content items; and
selecting, as the first supplemental content item, the supplemental content item whose characteristics have the greatest similarity with the one or more characteristics of the user and the one or more characteristics of the first core content.

4. A method according to claim 1, wherein selecting the first supplemental content item comprises:
selecting a subset of supplemental content items from the plurality of supplemental content items, wherein each supplemental content item in the subset of supplemental content items has one or more characteristics that correspond to the one or more characteristics of the first core content.

5. A method according to claim 4, wherein selecting the first supplemental content item further comprises:
ranking the subset of supplemental content items according to a similarity between characteristics of each supplemental content item in the subset of supplemental content items and the one or more characteristics of the user; and
selecting the first supplemental content item based on the ranking.

6. A method according to claim 1, further comprising:
selecting from the plurality of supplemental content items a second supplemental content item to be presented with second core content, the selecting based at least in part on the one or more characteristics of the user, one or more characteristics of the second core content, one or more characteristics of the second supplemental content item, and the first supplemental content item.

7. A method according to claim 1, further comprising:
rejecting a supplemental content item in the plurality of supplemental content items as unsuitable for presentation to the user based at least in part on the one or more characteristics of the user.

8. A method according to claim 1, further comprising:
presenting the first core content and the first supplemental content item to the user;
monitoring a user interaction with the first core content and/or the first supplemental content item to acquire user interaction data; and
selecting a third supplemental content item from the plurality of supplemental content items to be presented with third core content based at least in part on the one or more characteristics of the user, one or more characteristics of the third core content, one or more characteristics of the third supplemental content item and the user interaction data.

9. A method according to claim 8, wherein the monitored user interaction data comprises at least one of:
a posture of the user as the user interacts with the first core content and/or the first supplemental content item;
an amount of time spent interacting with the first core content and/or the first supplemental content item;
a physiological or psychological response of the user as the user interacts with the first core content and/or the first supplemental content item;
a measured distance between the user and the first core content and/or the first supplemental content item;
a reaction or response of the user to the first core content and/or the first supplemental content item, the reaction or response received via a user interface; and
a physical interaction between the user and a device on which the first core content and/or the first supplemental content item are presented.

10. A method according to claim 1, wherein obtaining one or more characteristics of the user comprises receiving data from at least one sensor associated with the user.

11. A method according to claim 10, wherein the at least one sensor comprises a camera; and
wherein obtaining one or more characteristics of the user comprises performing an image recognition process on an image acquired by the camera to obtain the one or more characteristics of the user.

12. A method according to claim 10, wherein the at least one sensor measures one or more physiological, behavioural and/or psychological characteristics of the user.

13. A method according to claim 1, wherein each of the plurality of supplemental content items comprises at least a portion or element of a photograph, a video, an audio clip, an image, a cartoon, an animation, an illustration, an emoticon, an olfactory presentation or a haptic presentation.

14. A method according to claim 1, further comprising:
generating a customised supplemental content item by combining together a plurality of selected supplemental content items.

15. A method according to claim 1, further comprising:
modifying the selected first supplemental content item based on the one or more characteristics of the user and/or the one or more characteristics of the first core content.

16. A method according to claim 1, wherein the one or more characteristics of the user comprise at least one of a physical characteristic, a characteristic associated with the location of the user, a characteristic associated with a user activity, and a characteristic associated with a behaviour of the user.

17. A method according to claim 1, wherein the one or more characteristics of the first core content comprise at least one of: a date, a season and/or a time that the first core content is scheduled to be delivered to the user; and a word or character present in the first core content.

18. A method according to claim 1, wherein the one or more characteristics of the first supplemental content item comprise at least one of:
a characteristic of a subject depicted in the first supplemental content item; and
a context of a subject depicted in the first supplemental content item.

19. An apparatus comprising:
a content item presentation module for presenting core content and supplemental content to a user; and
a processor;
wherein the apparatus is configured to perform the method of claim 1.

20. A computer program product comprising a non-transitory computer readable medium, the computer readable medium having computer readable code embodied therein, the computer readable code being configured such that, on execution by a suitable computer or processor, the computer or processor is caused to perform the method of claim 1.
